(19) United States
(12) Patent Application Publication
(10) Pub. No.: US 2014/0022341 A1
(43) Pub. Date: Jan. 23, 2014

(54) STEREOSCOPIC VIDEO IMAGE TRANSMISSION APPARATUS, STEREOSCOPIC VIDEO IMAGE TRANSMISSION METHOD, AND STEREOSCOPIC VIDEO IMAGE PROCESSING APPARATUS

(71) Applicant: KABUSHIKI KAISHA TOSHIBA, Tokyo (JP)

(72) Inventor: Takashi Minemura, Ome-shi (JP)

(73) Assignee: KABUSHIKI KAISHA TOSHIBA, Tokyo (JP)

(21) Appl. No.: 13/771,529

(22) Filed: Feb. 20, 2013

(30) Foreign Application Priority Data
Jul. 18, 2012 (JP) 2012-159818

(51) Int. Cl. H04N 13/00

(52) U.S. Cl. CPC H04N 13/0059
USPC 348/43

(57) ABSTRACT

According to one embodiment, a stereoscopic video image transmission apparatus includes a generator and a transmitter. The generator is configured to generate depth information from first and second stereoscopic video image displaying video signals having parallax. The transmitter is configured to wirelessly transmit the first and second video signals and the depth information generated by the generator to an external device. The external device generates the depth information from the first and second video signals and displays the stereoscopic video image by multiparallax system.

### CROSS-REFERENCE TO RELATED APPLICATIONS

This application is based upon and claims the benefit of priority from Japanese Patent Application No. 2012-159818, filed Jul. 18, 2012, the entire contents of which are incorporated herein by reference.

### FIELD

Embodiments described herein relate generally to a stereoscopic video image transmission apparatus that transmits stereoscopic video image displaying information, a stereoscopic video image transmission method, and a stereoscopic video image processing apparatus.

### BACKGROUND

As is well known, conventionally a technology of causing a user to recognize an image having a stereoscopic effect using a planar video display screen is developed. In the technology, two kinds of video images having parallax corresponding to the distance between the human eyes are prepared, and a right-eye video image is visually recognized by the right eye of the user while a left-eye video image is visually recognized by the left eye of the user.

Specifically, the right- and left-eye video images are alternately displayed on the same video display screen, and stereoscopic glasses worn by the user are controlled such that a left-eye shutter is closed when the right-eye video image is displayed and a right-eye shutter is closed when the left-eye video image is displayed, whereby the user recognizes the stereoscopic video image.

There is also practical application of a glasses-free stereoscopic video image display technology by what is called a multiparallax system, in which many parallax video images having different viewpoints are displayed on the video display screen such that by controlling the outgoing directions of ray from the parallax video image using ray controlling elements, such as lenses and barriers, which cover the screen, the user is caused to recognize a stereoscopic moving image without stereoscopic glasses.

In the stereoscopic video image display technology by the multiparallax system, depth information corresponding to a position deviation of the same object between the right- and left-eye video images is generated from the right- and left-eye video images, and many images having different viewpoints are generated and displayed in order to produce parallax in a wide range of the screen based on one of right- and left-eye video images and the depth information.

Nowadays high performance of mobile information terminals progresses. When a mobile information terminal is used as a source device, use of wireless transmission is useful to the user compared with wired transmission with respect to means for transmitting information to a sink device.

Therefore, the mobile information terminal that is of the source device wirelessly transmits the stereoscopic video image displaying right- and left-eye video images, and the sink device receives the right- and left-eye video images to generate the depth information, whereby the sink device implements glasses-free stereoscopic video image display by the multiparallax system.

When the wireless transmission is used as the information transmission means, reliability of a transmission line is degraded, increasing a packet error generating ratio. In an audiovisual (AV) stream of video data and audio data, the data is transmitted continuously. Therefore, frequently the sink device displays the video image using a video signal in which an error portion is incompletely corrected.

In the sink device, the depth information is generated from the right- and left-eye video images while the error portion is incompletely corrected. In this case, when the false depth information is generated, the stereoscopic video image displayed by the multiparallax system in the sink device is hardly seen by the user such that a depth direction is inverted.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a configuration diagram schematically illustrating an example of a transmission system according to an embodiment;

FIG. 2 is a block diagram schematically illustrating an example of a signal processing system of a digital television broadcast receiving device constituting the transmission system of the embodiment;

FIG. 3 is a block diagram schematically illustrating an example of a signal processing system of a mobile information terminal constituting the transmission system of the embodiment; and

FIG. 4 is a flowchart illustrating an example of a main processing operation performed by the mobile information terminal constituting the transmission system of the embodiment.

### DETAILED DESCRIPTION

Various embodiments will be described hereinafter with reference to the accompanying drawings.

In general, according to one embodiment, a stereoscopic video image transmission apparatus includes a generator and a transmitter. The generator is configured to generate depth information from first and second stereoscopic video image displaying video signals having parallax. The transmitter is configured to wirelessly transmit the first and second video signals and the depth information generated by the generator to an external device. The external device generates the depth information from the first and second video signals and displays the stereoscopic video image by multiparallax system.

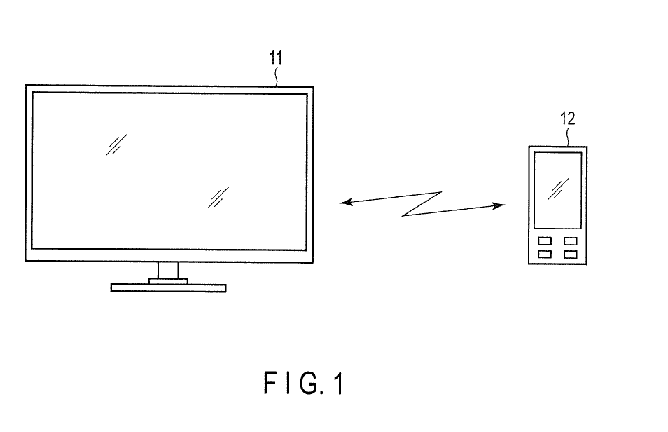

FIG. 1 schematically illustrates an example of a transmission system of the embodiment. That is, in the transmission system, a digital television broadcast receiving device 11 that is an example of the sink device and a mobile information terminal 12 that is an example of the source device are set such that the information can be transmitted by a system conformant with a predetermined wireless transmission standard.

The digital television broadcast receiving device 11 can receive a digital television broadcast signal, decode a video signal and an audio signal of a desired channel, and display a moving image and play back sound. The digital television broadcast receiving device 11 can also receive the video signal and the audio signal, which are wirelessly transmitted from the mobile information terminal 12, and display the moving image and play back the sound.

In this case, the digital television broadcast receiving device 11 includes a function of displaying a glasses-free stereoscopic video image by the multiparallax system. In the case that the video signal decoded from the digital television broadcast signal or the video signal acquired from the mobile information terminal 12 is the stereoscopic view display video signal, namely, a right-eye video signal and a left-eye video signal in a side-by-side system, a top-and-bottom system, a frame-packing system, and the like, the depth information is generated from the right- and left-eye video signals, and a multiparallax signal is generated and used to display the video image based on one of the right- and left-eye video signals and the depth information, which allows the stereoscopic video image to be displayed by the multiparallax system.

In other words, the digital television broadcast receiving device 11 analyzes the parallax video image to generate the depth information, performs processing of increasing the number of parallaxes of the parallax video image using the depth information, and displays the glasses-free stereoscopic video image using the multiparallax video image obtained through the processing.

In the case that the video signal decoded from the digital television broadcast signal or the video signal acquired from the mobile information terminal 12 is a normal planar view display video signal, the digital television broadcast receiving device 11 displays the normal planar video image based on the planar view display video signal.

On the other hand, the mobile information terminal 12 includes a telephone function, an electronic mail function, a camera function, a broadcast signal receiving function, a function of accessing a server on a network, and the like, and can display the moving image and play back the sound using the video signal and the audio signal, which are acquired by various functions. The mobile information terminal 12 wirelessly transmits the acquired video and audio signals to the digital television broadcast receiving device 11, and the digital television broadcast receiving device 11 can use the video and audio signals to display the moving image and play back the sound.

In the case that the video signals are the stereoscopic view display right- and left-eye video signals, the mobile information terminal 12 includes a function of generating the depth information from the video signals. When being requested to transmit the stereoscopic view display video signal to the digital television broadcast receiving device 11, the mobile information terminal 12 wirelessly transmits the right- and left-eye video signals and the depth information generated by the mobile information terminal 12, and wirelessly transmits an instruction signal to stop the generation of the depth information to the digital television broadcast receiving device 11.

When receiving the right- and left-eye video signals, the depth information, and the instruction signal to stop the generation of the depth information from the mobile information terminal 12, the digital television broadcast receiving device 11 stops the generation of the depth information, generates the multiparallax signal and uses the multiparallax signal to display the video image based on one of the right- and left-eye video signals received from the mobile information terminal 12 and the depth information. Therefore, the stereoscopic video image can be displayed by the multiparallax system.

That is, the mobile information terminal 12 that is of the source device generates the depth information from the right- and left-eye video signals and wirelessly transmits the depth information, and the digital television broadcast receiving device 11 that is of the sink device displays the stereoscopic video image by the multiparallax system using the depth information transmitted from the mobile information terminal 12 but does not generate the depth information.

The digital television broadcast receiving device 11 does not generate the depth information but the mobile information terminal 12 generates the depth information and transmits the depth information to the digital television broadcast receiving device 11. Therefore, reliability of the depth information used by the digital television broadcast receiving device 11 can be enhanced compared with the case that the digital television broadcast receiving device 11 generates the depth information based on the right- and left-eye video signals received from the mobile information terminal 12.

That is, because the depth information is a signal that does not have a high-frequency component in which many large contrast changes exist over a small range, like a stripe pattern, but usually includes a low-frequency component, even if high-frequency noise is superimposed in the course of wireless transmission, the reception side can, advantageously, perform low-pass filtering to easily remove the noise, and the quality is easily maintained.

However, because the video signal usually does have a high-frequency component, when high-frequency noise is superimposed in the course of wireless transmission, the reception side cannot remove the noise by simple smoothing using a low-pass filter, and the error generating ratio is increased during the wireless transmission as described above.

Therefore, the right- and left-eye video signals received from the mobile information terminal 12 by the digital television broadcast receiving device 11 includes many error portions to degrade the reliability of the depth information, which is generated based on the right- and left-eye video signals. When the digital television broadcast receiving device 11 generates the false depth information, the stereoscopic video image displayed by the multiparallax system based on the false depth information is hardly seen by the user such that the depth direction is inverted.

In the embodiment, the mobile information terminal 12 that is of the source device generates and wirelessly transmits the depth information, and the digital television broadcast receiving device 11 that is of the sink device displays the stereoscopic video image by the multiparallax system using the high-reliability depth information which is received from the mobile information terminal 12 and in which the noise is removed, so that the user-friendly stereoscopic video image can be displayed.

The digital television broadcast receiving device 11 including the function of displaying the glasses-free stereoscopic video image by the multiparallax system originally includes a function of receiving the right- and left-eye video signals from the mobile information terminal 12 to generate the depth information. Therefore, in the embodiment, effectively the mobile information terminal 12 transmits the instruction signal to stop the generation of the depth information to the digital television broadcast receiving device 11 such that the digital television broadcast receiving device 11 does not generate the depth information.

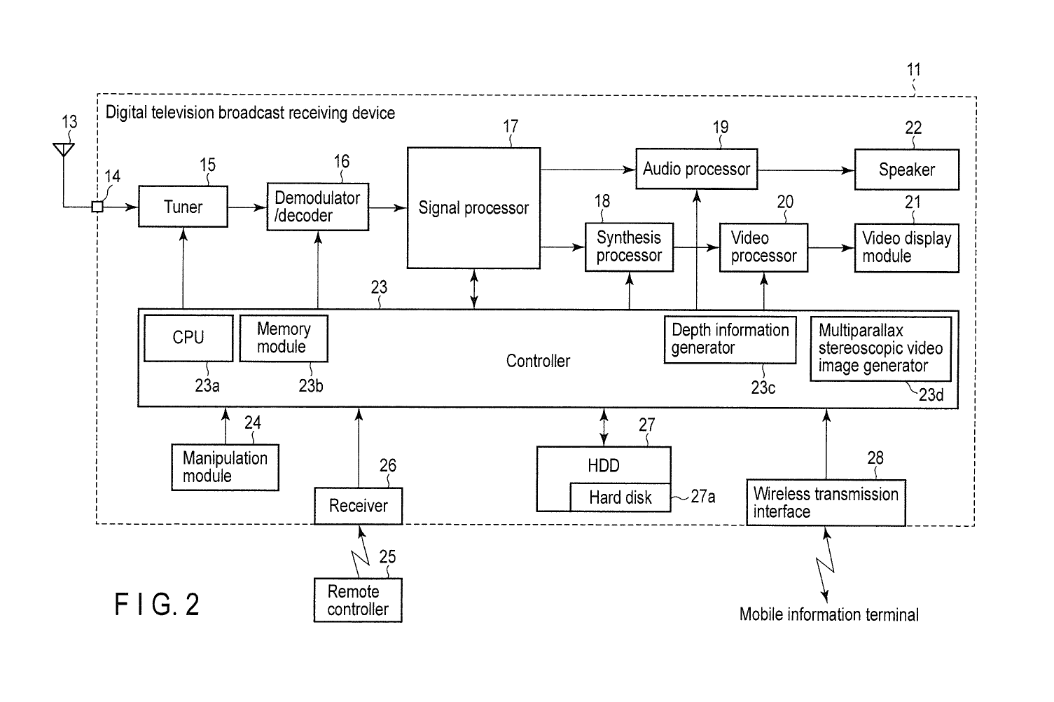

FIG. 2 schematically illustrates an example of a signal processing system of the digital television broadcast receiving device 11. As described above, the digital television broadcast receiving device 11 includes not only the video image displaying function based on the planar view display video signal but also the function of displaying the glasses-free stereoscopic video image by the multiparallax system.

That is, the digital television broadcast signal received by an antenna 13 is supplied to a tuner 15 through an input terminal 14, thereby selecting the broadcast signal of the desired channel. The broadcast signal selected by the tuner 15 is supplied to a demodulator/decoder 16 and decoded into the digital video and audio signals. Then the digital video and audio signals are output to a signal processor 17.

The signal processor 17 performs predetermined digital signal processing to the digital video and audio signals, which are supplied from the demodulator/decoder 16. The predetermined digital signal processing performed by the signal processor 17 includes processing of converting the normal planar view display video signal into the stereoscopic view display video signal by the multiparallax system and processing of converting the stereoscopic view display right- and left-eye video signals into the planar view display video signal.

The signal processor 17 outputs the digital video signal to a synthesis processor 18, and outputs the digital audio signal to an audio processor 19. The synthesis processor 18 superimposes an on-screen display (OSD) signal on the digital video signal, which is supplied from the signal processor 17, and outputs the superimposed digital video signal. The digital video signal output from the synthesis processor 18 is supplied to a video processor 20.

The video processor 20 converts the input digital video signal into a video signal having a format, in which the digital video signal can be displayed by a subsequent flat-screen video display module 21 including a liquid crystal display panel. The video signal output from the video processor 20 is supplied to the video display module 21 to display the video image.

The audio processor 19 converts the input digital audio signal to an audio signal having a format, in which the digital audio signal can be played back by a subsequent speaker 22. An analog audio signal output from the audio processor 19 is supplied to the speaker 22, and used to play back the sound.

At this point, a controller 23 wholly controls various operations, which includes the above various receiving operations, of the digital television broadcast receiving device 11. The controller 23 is provided with a central processing unit (CPU) 23a. The controller 23 receives manipulation information from a manipulation module 24 provided in a main body of the digital television broadcast receiving device 11 or manipulation information, which is transmitted from a remote controller 25 and received by a receiver 26, whereby the controller 23 controls each module such that a manipulation content of the manipulation information is reflected.

In this case, the controller 23 uses a memory module 23b. The memory module 23b includes a read-only memory (ROM) in which a control program executed by the CPU 23a is stored, a random access memory (RAM) that provides a work area to the CPU 23a, and a nonvolatile memory in which various items of setting information and various items of control information are stored.

A hard disk drive (HDD) 27 is connected to the controller 23. Based on a user manipulation of the manipulation module 24 or the remote controller 25, the controller 23 can perform the control such that the digital video and audio signals obtained from the signal processor 17 are supplied to the HDD 27, and such that the digital video and audio signals are recorded on a hard disk 27a of the HDD 27.

Based on a user manipulation of the manipulation module 24 or the remote controller 25, the controller 23 can perform the control such that the HDD 27 reads the digital video and audio signals from the hard disk 27a, and such that the digital video and audio signals are supplied to the signal processor 17 in order to use the digital video and audio signals to display the moving image and play back the sound.

A wireless transmission interface 28 is connected to the controller 23. The wireless transmission interface 28 includes a function of transmitting and receiving the information to and from the external mobile information terminal 12 that is of the source device by a system conformant with a predetermined wireless transmission standard. Therefore, the controller 23 can wirelessly transmit and receive the information to and from the mobile information terminal 12 through the wireless transmission interface 28. For example, the controller 23 can receive the right- and left-eye video signals, the depth information, and the instruction signal to stop the generation of the depth information from the mobile information terminal 12.

A depth information generator 23c is also provided in the controller 23. In the case that the video signals decoded from the digital television broadcast signal or the video signals acquired from the mobile information terminal 12 are the stereoscopic view display right- and left-eye video signals, the depth information generator 23c generates the depth information from the right- and left-eye video signals. In the case that the instruction signal to stop the generation of the depth information is received from the mobile information terminal 12, the depth information generator 23c stops the generation of the depth information.

A multiparallax stereoscopic video image generator 23d is provided in the controller 23. The multiparallax stereoscopic video image generator 23d generates the multiparallax signal based on one of the right- and left-eye video signals and the depth information. The video display module 21 uses the video signal generated by the multiparallax stereoscopic video image generator 23d to display the video image, whereby the stereoscopic video image can be displayed by the multiparallax system.

In this case, when the instruction signal to stop the generation of the depth information while the right- and left-eye video signals and the depth information are received from the mobile information terminal 12, the multiparallax stereoscopic video image generator 23d generates the multiparallax signal based on one of or both the received right- and left-eye video signals and the received depth information.

The multiparallax stereoscopic video image generator 23d performs low-pass filtering to the depth information received from the mobile information terminal 12, and generates the multiparallax signal using the post-low-pass-filtering depth information. The depth information including low-frequency information can be taken out by performing the low-pass filtering even in a transmission-line environment in which high-frequency noise arrives after being superimposed on the depth information. The digital television broadcast receiving device 11 performs the low-pass filtering to the depth information, but may not perform the low-pass filtering video signal that is used to generate the multiparallax signal.

That is, in the he digital television broadcast receiving device 11, in the case that the video signals decoded from the digital television broadcast signal or the video signals acquired from the mobile information terminal 12 are the stereoscopic view display right- and left-eye video signals, the depth information generator 23c generates the depth information from the right- and left-eye video signals. The multiparallax stereoscopic video image generator 23d generates the multiparallax signal based on one of the right- and left-eye video signals and the depth information generated by the depth information generator 23c, whereby the stereoscopic video image is displayed by the multiparallax system.

In the digital television broadcast receiving device 11, the depth information generator 23c stops the generation of the depth information in the case that the instruction signal to stop the generation of the depth information while the right- and left-eye video signals and the depth information are received from the mobile information terminal 12. The multiparallax stereoscopic video image generator 23d generates the multiparallax signal based on one of the received right- and left-eye video signals and the received depth information, whereby the stereoscopic video image is displayed by the multiparallax system.

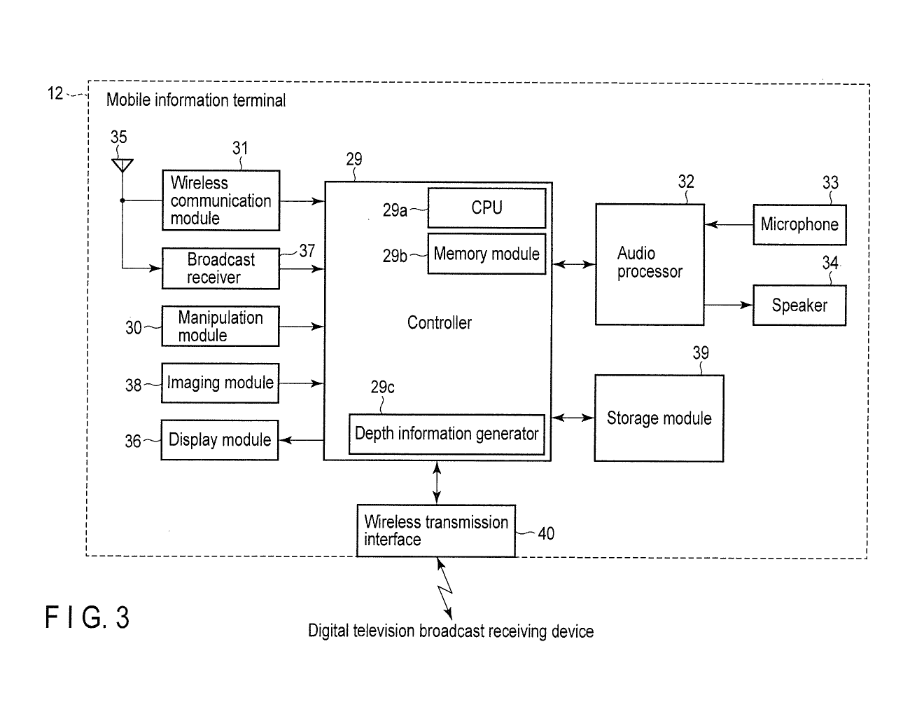

FIG. 3 schematically illustrates an example of a signal processing system of the mobile information terminal 12. That is, the mobile information terminal 12 includes a controller 29 that wholly controls all the operations of the mobile information terminal 12. The controller 29 includes a CPU 29a. The controller 29 receives manipulation information from a manipulation module 30, whereby the controller 29 controls each module such that a manipulation content of the manipulation information is reflected.

In this case, the controller 29 uses a memory module 29b. The memory module 29b includes a ROM in which a control program executed by the CPU 29a is stored, a RAM that provides a work area to the CPU 29a, and a nonvolatile memory in which various items of setting information and various items of control information are stored.

A wireless communication module 31 and an audio processor 32 are connected to the controller 29. A microphone 33 and a speaker 34 are connected to the audio processor 32. The controller 29 transmits the audio signal, which is collected by the microphone 33 and supplied through the audio processor 32, from an antenna 35 through the wireless communication module 31. The controller 29 supplies the signal, which is received by the antenna 35 and supplied through the wireless communication module 31, to the speaker 34 through the audio processor 32, and plays back the signal as the audio signal. Therefore, the controller 29 implements the telephone function.

The controller 29 controls the transmission and reception of the electronic mail through the wireless communication module 31 and the antenna 35. In this case, the controller 29 causes a display module 36 to display texts of the transmitted and received electronic mails.

The controller 29 accesses a server (not illustrated) connected to networks, such as the Internet, through the wireless communication module 31 and the antenna 35, and can acquire necessary information by wireless communication.

A broadcast receiver 37 may be connected to the controller 29. The broadcast receiver 37 selects and demodulates the broadcast signal of the desired channel from the broadcast signal received through the antenna 35, generates the video and audio signals, and supplies the video and audio signals to the controller 29. Therefore, the controller 29 causes the display module 36 to display the video image based on the video signal, and causes the speaker 34 to play back the sound based on the audio signal, thereby implementing the broadcast receiving function.

An imaging module 38 is connected to the controller 29. The imaging module 38 generates the video signal corresponding to a subject optical image incident through an imaging lens (not illustrated), and supplies the video signal to the controller 29. The controller 29 stores the video signal supplied from the imaging module 38 in a storage module 39, thereby implementing the camera function.

The controller 29 includes a function of reading the video and audio signals, which are of copyright protection contents that are stored in an external storage device (not illustrated) detachably attached to the mobile information terminal 12.

The controller 29 can store various video and audio signals, which are transmitted and received by the telephone function, the electronic mail function, the broadcast receiving function, the camera function, and the network accessing function in the storage module 39.

A depth information generator 29c is provided in the controller 29. In the case that the video signals acquired by the mobile information terminal 12 using the various functions are the stereoscopic view display right- and left-eye video signals, the depth information generator 29c generates the depth information from the right- and left-eye video signals.

In the case that the controller 29 reads items of information, such as game software, from the storage module 39, a portable medium, or a server, stereoscopic view information including three-dimensional polygon data is acquired, and the depth information may be generated from the stereoscopic view information.

A wireless transmission interface 40 is connected to the controller 29. The wireless transmission interface 40 includes a function of transmitting and receiving the information to and from the external digital television broadcast receiving device 11 that is of the sink device by a system conformant with a predetermined wireless transmission standard. Therefore, the controller 29 can wirelessly transmit and receive the information to and from the digital television broadcast receiving device 11 through the wireless transmission interface 40. For example, the controller 29 can transmit the right- and left-eye video signals, the depth information, and the instruction signal to stop the generation of the depth information from the digital television broadcast receiving device 11.

The wireless transmission interface 40, and the wireless communication module 31 and the antenna 35 may be combined, namely, a source wireless reception HW and a wireless transmission HW from the source device to the sink device may commonly be used in a time-sharing manner. Therefore, for example, when a source content is a moving image of the Web, the moving image is wirelessly transmitted to the sink device while wirelessly received by the source device.

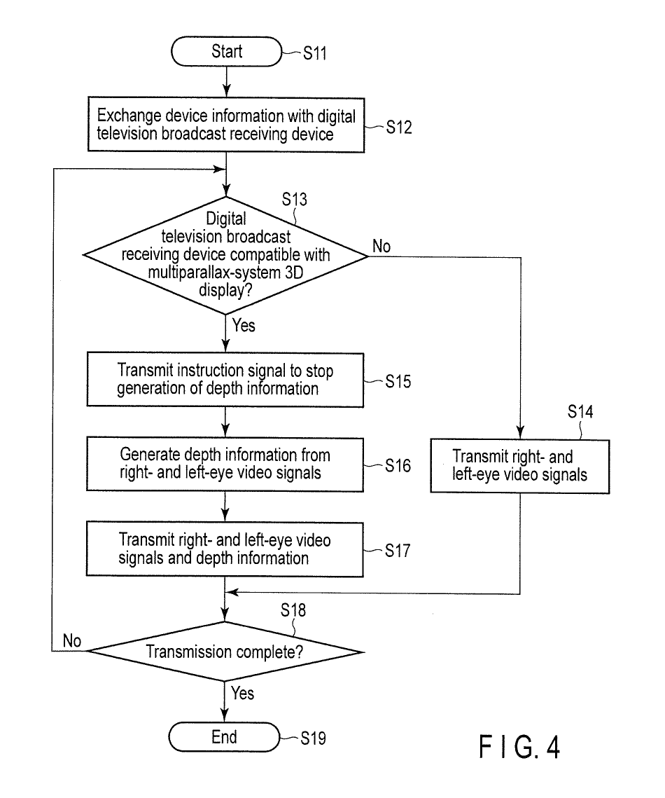

FIG. 4 is a flowchart illustrating an example of a main processing operation performed by the controller 29 of the mobile information terminal 12 when the mobile information terminal 12 wirelessly transmits the stereoscopic view display video signal to the digital television broadcast receiving device 11.

When the processing is started (Step S11), the controller 29 exchange the device information (capability) with the digital television broadcast receiving device 11 in Step S12. Examples of the exchanged device information include information indicating a type of the device, information indicating a codec (a compression system) of the video or audio signal, information indicating the number of compliant pixels, and information indicating the stereoscopic video image displaying system.

In Step S13, the controller 29 determines whether the digital television broadcast receiving device 11 is compatible with the stereoscopic video image display by the multiparallax system based on the acquired device information. When the digital television broadcast receiving device 11 is not compatible with the stereoscopic video image display by the multiparallax system (NO in Step S13), the controller 29 determines that the digital television broadcast receiving device 11 is compatible with the stereoscopic video image display by the system in which the stereoscopic view glasses are used. In Step S14, the controller 29 transmits the right- and left-eye video signals to the digital television broadcast receiving device 11.

When the digital television broadcast receiving device 11 is compatible with the stereoscopic video image display by the multiparallax system (YES in Step S13), the controller 29 transmits the instruction signal to stop the generation of the depth information by the depth information generator 23c to the digital television broadcast receiving device 11 in Step S15.

In Step S16, using the depth information generator 29c, the controller 29 generates the depth information from the right- and left-eye video signals transmitted to the digital television broadcast receiving device 11.

In Step S17, the controller 29 transmits the right- and left-eye video signals and the depth information generated by the depth information generator 29c to the digital television broadcast receiving device 11. That is, the controller 29 transmits the right- and left-eye video signals and the depth information to the device compatible with the stereoscopic video image display by the multiparallax system, namely, the device compatible with the generation of the depth information. The digital television broadcast receiving device 11 generates the multiparallax signal to perform the stereoscopic video image display by the multiparallax system based on one of the received right- and left-eye video signals and the received depth information.

After Step S14 or Step S17, the controller 29 determines whether the transmission of the video signal is complete in Step S18. If the transmission of the video signal is not complete (NO in Step S18), the processing is returned to Step S13. If the transmission of the video signal is complete (YES in Step S18), the processing is ended (Step S19).

In the flowchart in FIG. 4, the mobile information terminal 12 may generate and transmit the depth information according to the other party. For example, in the case that digital television broadcast receiving device 11 is constructed so as to generate depth information in which a stereoscopic effect of the video image is enhanced compared with depth information generated by the general device, the mobile information terminal 12 may acquire information (for example, information indicating a degree of the enhancement of the depth information) on the generation of the depth information of the digital television broadcast receiving device 11 during the exchange of the device information, and generate the depth information based on the information.

When the digital television broadcast receiving device 11 displays the video image by the multiparallax system, the mobile information terminal 12 may acquire the items of device information on the number of parallaxes and screen resolution, and generate the depth information resolution is decreased according to the number of parallaxes and the screen resolution.

According to the embodiment, in the case that the digital television broadcast receiving device 11 is compatible with the stereoscopic video image display by the multiparallax system, the mobile information terminal 12 transmits the right- and left-eye video signals and the depth information generated by the mobile information terminal 12 to the digital television broadcast receiving device 11, and transmits the instruction signal to stop the generation of the depth information to the digital television broadcast receiving device 11.

The digital television broadcast receiving device 11 stops the generation of the depth information, and generates the multiparallax signal to perform the stereoscopic video image display by the multiparallax system based on one of the right- and left-eye video signals and the depth information, which are received from the mobile information terminal 12.

That is, the digital television broadcast receiving device 11 that is of the sink device does not generate the depth information from the right- and left-eye video signals in which the reliability is degraded due to the wireless transmission, but performs the stereoscopic video image by the multiparallax system using the high-reliability depth information received from the mobile information terminal 12, so that user-friendly stereoscopic video image can be displayed.

The digital television broadcast receiving device 11 needs not to generate the depth information, so that a delay of the processing necessary to generate the depth information can be eliminated to shorten a time necessary for the video image processing. Therefore, for example, even if the video image of the game played on the mobile information terminal 12 is displayed on the digital television broadcast receiving device 11, the video image can be displayed without an uncomfortable feeling caused by the processing delay. The number of horizontal or vertical pixels of the transmitted depth information is a value in which the total number of pixels on the display screen is divided by the number of generated parallaxes.

The digital television broadcast receiving device 11 including the function of displaying the stereoscopic video image by the multiparallax system originally receives the right- and left-eye video signals, and generates the depth information from the right- and left-eye video signals. Therefore, usefully the mobile information terminal 12 transmits the instruction signal to stop the generation of the depth information such that the digital television broadcast receiving device 11 does not generate the depth information.

The depth information generator 23c of the digital television broadcast receiving device 11 may be provided with a function of determining that the depth information is included together with the right- and left-eye video signals by analyzing header information on a stream received from the mobile information terminal 12, and a function of automatically stopping the generation of the depth information of the depth information generator 23c. Therefore, it is not necessary for the mobile information terminal 12 to transmit the explicit instruction signal to stop the generation of the depth information.

For example, when the right- and left-eye video signals stored in the medium are read to display the multiparallax video image, the digital television broadcast receiving device 11 generates the depth information using the own depth information generating function, and generates the multiparallax signal using the read right- and left-eye video signals and the generated depth information.

On the other hand, when the video signals and the depth information are transmitted from the mobile information terminal 12, the digital television broadcast receiving device 11 generates the multiparallax signal using not the depth information generated by the digital television broadcast receiving device 11 but the received depth information. At this point, the digital television broadcast receiving device 11 performs the low-pass filtering, in which the low-frequency information is extracted, on the received depth information, but does not perform the low-pass filtering on the received video signals.

In the embodiment, the mobile information terminal 12 transmits the right- and left-eye video signals and the depth information to the digital television broadcast receiving device 11. Alternatively, for example, the mobile information terminal 12 may transmit the right-eye video signal, the left-eye video signal, right-eye video image depth information for the right-eye video signal, and left-eye video image depth information for the left-eye video signal to the digital television broadcast receiving device 11.

One of the right-eye video image depth information and the left-eye video image depth information may be transmitted in addition to the right- and left-eye video signals. In this case, whether both items of depth information or one of the items of depth information is transmitted can properly be selected according to transmission quality of wireless transmission line. In the case that one of the items of depth information is transmitted, only the depth information to be transmitted may be generated.

The mobile information terminal 12 may generate the depth information from the right- and left-eye video signals, and transmit one of the right- and left-eye video signals and the depth information. Alternatively, a center video image that is one parallax-free video image is generated based on the right- and left-eye video signals, and the center video image and the depth information may be transmitted. In this case, the multiparallax stereoscopic video image generator 23d of the digital television broadcast receiving device 11 generates the multiparallax signal based on the center video image and the depth information, which are received from the mobile information terminal 12.

The depth information generator 29c of the mobile information terminal 12 may generate not only the depth information from the right- and left-eye video signals but also the depth information from the planar view display (2D display) video signal by what is called a 2D-3D conversion. In this case, the mobile information terminal 12 may transmit the planar view display video signal and the depth information to the digital television broadcast receiving device 11.

In the embodiment, the digital television broadcast receiving device 11 is used as an example of the sink device, and the mobile information terminal 12 is used as an example of the source device. Alternatively, various devices may be used as the sink device and the source device. For example, the digital television broadcast receiving device may be used as the source device and the mobile information terminal may be used as the sink device.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic video image transmission apparatus comprising:
a generator configured to generate depth information from first and second stereoscopic video image displaying video signals having parallax; and
a transmitter configured to wirelessly transmit the first and second video signals and the depth information generated by the generator to an external device, the external device being capable of generating depth information from the first and second video signals and displaying a stereoscopic video image by a multiparallax system.

2. The stereoscopic video image transmission apparatus of claim 1, further comprising an acquisition module configured to acquire device information on the external device, wherein
the transmitter is configured to transmit the first and second video signals and the depth information generated by the generator when the external device indicated by the device information is compatible with the generation of the depth information after the acquisition module acquires the device information.

3. The stereoscopic video image transmission apparatus of claim 2, wherein the external device includes a function of extracting a low-frequency component of the depth information from the stereoscopic video image transmission apparatus.

4. The stereoscopic video image transmission apparatus of claim 1, wherein the transmitter is configured to transmit an instruction to the external device to stop the generation of the depth information.

5. The stereoscopic video image transmission apparatus of claim 1, wherein the generator is configured to generate at least one of first depth information for the first video signal and second depth information for the second video signal, and
the transmitter is configured to transmit at least one of the first and second items of depth information to the external device together with the first and second video signals.

6. The stereoscopic video image transmission apparatus of claim 5, wherein the transmitter is configured to set whether both the first and second items of depth information or one of the first and second items of depth information is transmitted according to transmission quality of a transmission line.

7. The stereoscopic video image transmission apparatus of claim 1, further comprising an information exchanger configured to exchange the device information with the external device, wherein
the transmitter is configured to transmit not the depth information but the first and second video signals when the device information acquired from the external device by the information exchanger indicates that the external device does not includes the function of displaying the stereoscopic video image by the multiparallax system.

8. The stereoscopic video image transmission apparatus of claim 1, further comprising an acquisition module configured to acquire device information on the external device, wherein
the generator is configured to generate the depth information corresponding to the external device based on the device information.

9. The stereoscopic video image transmission apparatus of claim 1, further comprising a reader configured to read stereoscopic view information, wherein
the generator is configured to generate the depth information from the read stereoscopic view information.

10. A stereoscopic video image transmission method comprising:
generating depth information from first and second stereoscopic video image displaying video signals having parallax; and
transmitting wirelessly the first and second video signals and the generated depth information to an external device, the external device generating depth information from the first and second video signals and displaying a stereoscopic video image by a multiparallax system.

11. A stereoscopic video image processing apparatus comprising:
a receiver configured to receive first and second stereoscopic video image displaying video signals having parallax and first depth information on the first and second video signals;
a generator configured to generate second depth information from the first and second video signals; and
a multiparallax signal generator configured to generate a multiparallax signal used to display a stereoscopic video image by a multiparallax system based on the first depth information when the first and second video signals and the first depth information are received from an information terminal.

12. The stereoscopic video image processing apparatus of claim 11, further comprising a processor configured to perform low-pass filtering, in which a low-frequency information is extracted, to the first depth information in the first and second video signals and the first depth information, which are received by the receiver, and not to perform the low-pass filtering to the first and second video signals, wherein
the multiparallax signal generator is configured to generate the multiparallax signal based on the first depth information to which the low-pass filtering is already performed.

13. The stereoscopic video image processing apparatus of claim 12, wherein the generator is configured to stop the generation of the second depth information when the first depth information is received from the information terminal.
